(19) United States
(12) Patent Application Publication
(10) Pub. No.: US 2014/0090540 A1
(43) Pub. Date: Apr. 3, 2014

(54) PICK FOR STRINGED INSTRUMENT

(71) Applicant: Mark Panagiotes, Fitchburg, MA (US)

(72) Inventor: Mark Panagiotes, Fitchburg, MA (US)

(73) Assignee: Hammerhead LLC, Fitchburg, MA (US)

(21) Appl. No.: 13/644,225

(22) Filed: Oct. 3, 2012

(51) Int. Cl. G10D 3/16

(52) U.S. Cl. 84/322

(57) ABSTRACT

A pick for a stringed musical instrument is disclosed, the pick having a substantially triangular shape and a top edge and two side edges that converge toward a tip. The tip may be used for strumming or picking a stringed instrument. The projection extends from one of the two side edges and contains an enlarged head disposed on its distal end. The enlarged head may be used for tapping or hammering the strings of a musical instrument. In use, the pick may be grasped along the top edge for strumming or picking and it may be rotated approximately ninety degrees to place the head on the projection into contact with strings on the musical instrument while the user grasps the other side edge.

### BACKGROUND OF INVENTION

1. Field of Invention

The present invention relates generally to guitar picks and, more specifically, to a guitar pick which can be used both to strum or to pick a guitar string in a conventional way, as well as to achieve a legato effect.

2. Related Art

Certain musical instruments such as guitars, mandolins and banjos, are played either with the fingers or with a pick or plectrum, which is used to hit or strum the strings of the instrument. The shape and surfaces of the pick dictate, to some degree, the types of sounds that may be created from the instrument. For example, a sharp pick surface is desired to make rapid single string picking in sequence, whereas a smooth surface is desirable when strumming several strings. Other techniques have evolved that are performed by a finger, but which would be enhanced by use of a pick. For example, a technique called finger tapping or hammering involves attacking a string with one finger of the picking hand to slam the string onto the fret board or finger board of the guitar and then thereafter pulling the string off at a slight angle. The sound of the string at the front where it is tapped is created, followed by the sound of the string in an open condition when the string is released. This technique can be used to achieve a legato effect. This technique also can be used in conjunction with an arpeggio type of sound.

Examples of existing picks are disclosed in U.S. Pat. Nos. 5,419,228 and 7,238,869.

### SUMMARY OF INVENTION

This invention relates generally to a pick to be used with a stringed musical instrument. The pick can be used to either strum or pick the strings of the musical instrument, or it can be rotated into a position where a head projecting from one side of the pick is used to hammer or tap the strings of a stringed instrument on the fret board (or finger board) to produce a legato effect or an arpeggio type of sound.

In one aspect, a pick for a stringed musical instrument is disclosed. In one embodiment, the pick has a generally triangular shape and includes a top edge and two side edges, the two side edges extending from the top edge and intersecting at a location spaced from the top edge to form a tip. In this embodiment, a projection extends from one of the two side edges in a direction generally parallel to at least a portion of the top edge. An enlarged head is disposed on an end of the projection spaced from the pick body.

In one embodiment, the outer surface of the head may have a rounded configuration. In another embodiment, the outer surface of the head has a generally planar configuration. In yet another embodiment, the head has a shape of a disc. In another embodiment, the head has a generally semi-cylindrical shape. In other embodiments, the projection extends from one of the two side edges in a direction which is generally perpendicular to a line extending from the top edge to the tip. In other embodiments, the pick body may have been roughened to enhance an ability to grasp the pick. The pick body may be formed of a plastic material, and the projection may be formed of a metal material.

In another aspect, a pick for a stringed musical instrument includes a pick body having a generally triangular shape. The pick body includes a top edge and first and second side edges, the first and second side edges extending from the top edge and converging toward one another at a tip. A projection extends from the first side edge away from the body, and a head is disposed on the distal end of the projection at a location spaced from the body. The body of the pick may be flexible relative to the projection and the head, and the top edge may be configured to be grasped by the hand of a musician to allow the musician to strum or pick the strings of a musical instrument. The pick may be rotatable through about 90° about an axis of rotation generally perpendicular to an outer surface of the pick body to allow the musician to grasp the pick along the second edge and to place the head into contact with strings on a musical instrument.

### BRIEF DESCRIPTION OF DRAWINGS

The objects, advantages and features of this invention will be more clearly appreciated from the following detailed description, when taken in conjunction with the accompanying drawings in which:

FIG. 1 is a front view of one embodiment of the pick of this invention;

FIG. 2 is a side, elevational view of the pick of FIG. 1;

FIG. 3 is a side, cross-sectional view taken along the lines 3-3 of FIG. 1;

FIG. 4 is a front, elevational view of another embodiment of the pick of the invention;

FIG. 5 is a side, cross-sectional view taken along the line 5-5 of FIG. 4;

FIG. 6 is a front, elevational view of another embodiment of the pick of this invention;

FIG. 7 is a side, cross-sectional view taken along the line 7-7 of FIG. 6;

FIG. 8 is a side view of the pick of FIG. 6;

FIG. 9 is a front, elevational view of yet another embodiment of the pick of this invention;

FIG. 10 is a side, cross-sectional view taken along the line 10-10 of FIG. 9; and

FIG. 11 is a side view of the pick of FIG. 9.

### DETAILED DESCRIPTION OF INVENTION

The present invention relates to a pick or plectrum for stringed instruments, particularly acoustic guitars and electric guitars. The pick of the invention includes a body which may have a conventional, generally triangular shape. The body includes a tip which may be used for conventional picking and/or strumming of a stringed instrument. A top edge is disposed opposite the tip and two side edges extend from the top edge and converge to form the tip. Extending from one side edge of the pick is a projection which may be used to tap or hammer the strings of the stringed instrument on the fret board to achieve a legato effect. The projection may have an enlarged shape at an outer end or head and may taper toward the body of the pick. Typically, this projection extends approximately parallel to at least a portion of the top edge and is spaced inwardly from the top edge. Different sized projections and heads may be used for different applications. In use, typically the top edge is gripped while strumming or picking the strings of the instrument while the other side edge is gripped when using the head to tap or hammer the strings.

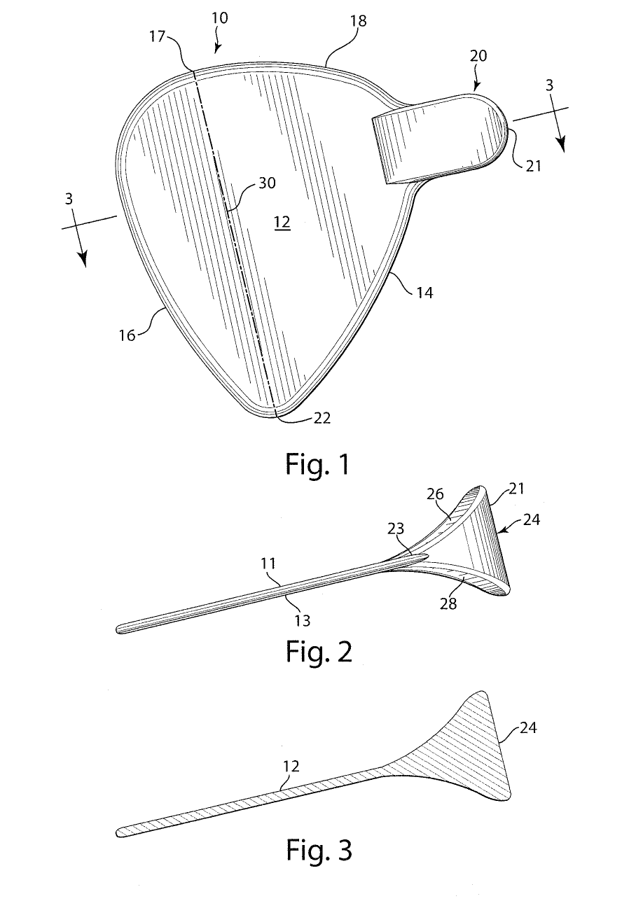

Referring now to the drawings, and particularly to FIG. 1 thereof, there is shown a perspective view of one embodiment of the pick 10 of the present invention. Pick 10 includes a body 12 which may have a substantially triangular shape and substantially planar top and bottom or surfaces 11 and 13. Body 12 typically has a very thin cross-sectional dimension to provide the flexibility desired for picking or strumming strings of a stringed instruments. Body 12 may include two side edges 14 and 16 and an upper edge 18. Edges 14 and 16 typically converge to form tip 22. As shown in FIG. 1, tip 22 has a generally rounded configuration, but in other embodiments, tip 22 could have a more sharply defined or pointed configuration. Tip 22 is typically used to strum or pick the strings of a stringed instrument. Edges 14, 16 and 18 may be linear or be slightly curved with a large radius of curvature. The embodiment of FIG. 1 discloses edges with a large radius of curvature.

Projection 20 may extend from edge 14, as shown in FIG. 1, although projection 20 could alternatively extend from edge 16. As shown more clearly in FIG. 2, projection 20 includes a base 23 and a head 24 at a distal end of base 23, where head 24 is enlarged with respect to base 23. Base 23 includes sides 26 and 28 on opposite sides of heads 24. Sides 26 and 28 may taper to the respective opposed surfaces 11 and 13 of body 12. While sides 26 and 28 are shown as being tapered, sides 26 and 28 instead may extend generally parallel to respective surfaces 11 and 13 of body 12. In one embodiment, projection 20 extends from edge 14 in a direction generally parallel to portion 17 of edge 18 near its juncture with edge 16. In another embodiment, projection 20 extends at an angle that is approximately 90 degrees with respect to a line 30 that is drawn from tip 22 to portion 17 and that intersects edge 18 at approximately a right angle with respect to portion 17.

It is to be understood, however, that the angle formed between projection 20 and line 30 need not be exactly 90 degrees, but could be between 60 degrees and 120 degrees. In addition, projection 20 need not extend from body 12 in a direction that is exactly parallel to portion 17 of edge 18, but could extend at an angle with respect to portion 17 which may vary between +30 or −30 degrees. Projection 20 typically is spaced inwardly from edge 18, particularly portion 17 of edge 18. In another embodiment, projection 20 may extend from body 12 at about the location of the junction between edges 14 and 18.

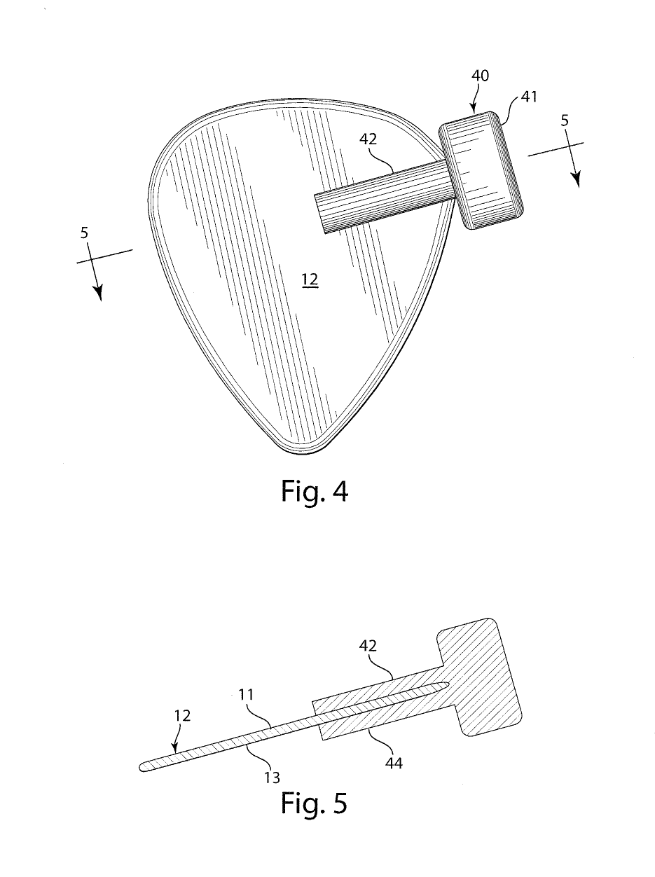

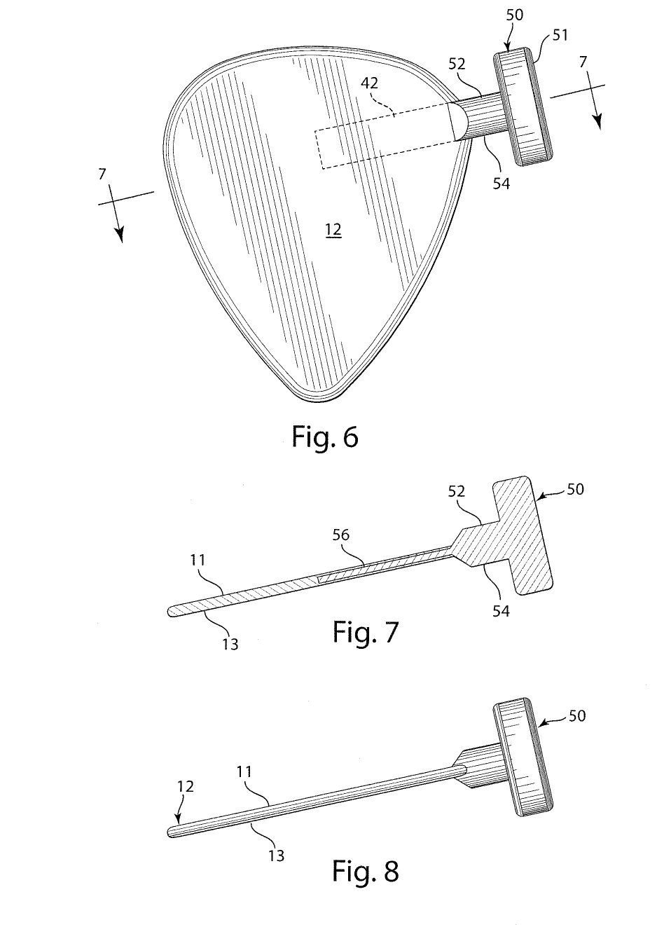

Head 24 may have a rounded configuration along its outer surface 21 facing away from body 12 as shown in FIG. 1. In one embodiment, head 24 has a semi-cylindrical shape. However, in other embodiments, as shown in FIGS. 4-8, the outer surface of head 40 or 50 may have a flat or planar configuration. For example, in the embodiment of FIG. 4, head 40 may have a disc shape with a flat or planar outer surface 41. In yet another embodiment, as shown in FIG. 6, head 50 may have a disc shape with a flat or planar outer surface 51. Head 50 may be thinner in cross-sectional thickness than head 40. Heads 40 and 50 may be provided with a greatly enlarged diameter in other embodiments. Heads 40 and 50 are particularly suitable for use with instruments having larger strings, such as a bass guitar.

As noted above with respect to FIGS. 1-3, in one embodiment, head 20 is provided with tapered sides 26 and 28 which extend from the outer surface 21 of head 24 and taper toward respective opposed surfaces 11 and 13 of body 12. In another embodiment, as shown in FIGS. 4 and 5, head 40 may be provided with two legs 42 and 44 which extend along and generally parallel to respective opposed surfaces 11 and 13 of body 12. Typically, legs 42 and 44 straddle body 12 of the pick. As shown in FIGS. 4 and 5, legs 42 and 44 typically have a rounded outer surface, but could have flattened outer surfaces, or could have any other suitable shape. In the embodiment of FIGS. 4 and 5, legs 42 and 44 are exposed on the outer surface of the pick.

In another embodiment, as shown in FIGS. 6-8, head 50 includes a single leg 52. Leg 52 extends from the underside of head 50 toward body 12 of pick 10. Leg 52 includes an enlarged upper portion 54, which tapers to a thinner portion 56. Portion 56 typically is embedded within body 12 such that it is captured between opposed surfaces 11 and 13. In this manner, no part of portion 56 of leg 52 is exposed or causes enlargement of the thickness of body 12, providing uniformly smooth and uninterrupted outer surfaces 11 and 13 for body 12. This configuration may be preferred by some musicians for ease of playing.

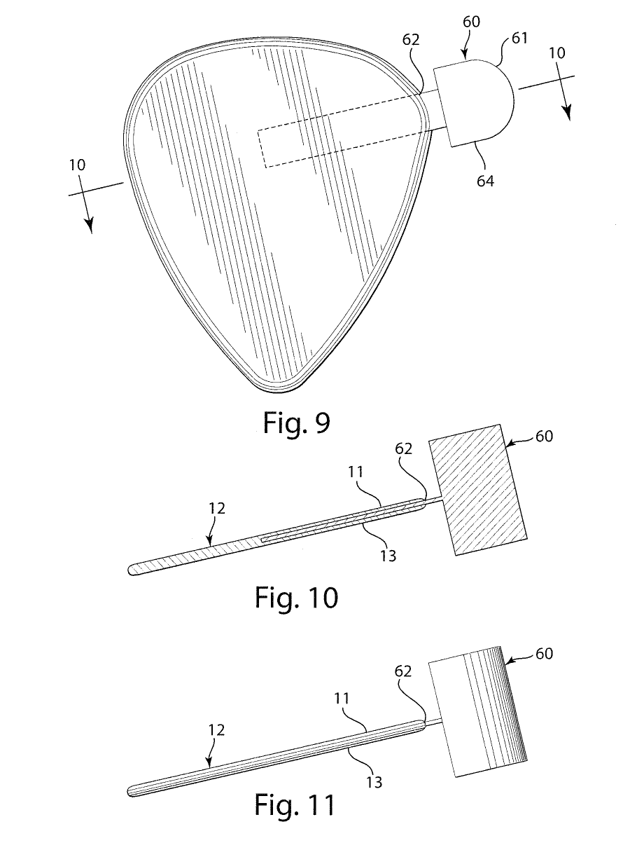

In yet another embodiment, as shown in FIGS. 9-11, head 60 may be provided with a single leg 62 which extends with a substantially uniform thickness from head 60 toward body 12 of pick 10. The lower portion of leg 62 is embedded within body 12 such that it resides between surfaces 11 and 13 of body 12. This embodiment again provides smooth, uniform outer surfaces 11 and 13. It is also noted that head 60 of this embodiment is provided with a generally semi-cylindrical configuration with a rounded upper surface 61, which extends to generally straight side surfaces 64 which extend generally parallel to stem 62. It is to be appreciated, however, that head 60 may have any other configuration, such as those shown for heads 40 or 50.

Body 12 typically is formed of materials conventionally used for picks for stringed instruments, such as hardened plastic or nylon. The use of such materials allows tip 22 to be used in a conventional fashion to provide the desired strumming or picking effect and to provide the desired sound quality. In some embodiments, surfaces 11 and 13 may be roughened to facilitate grasping.

In some embodiments, heads 24, 40, 50 and 60 may be formed of a metal, such as anodized aluminum or steel to provide more durability and to provide the desired sound from the stringed instrument. However, heads 24, 40, 50 and 60 may be formed of other hardened materials depending on the effect desired.

When being used, typically pick 10 of the present invention may be held between the thumb and the forefinger of the hand near top edge 18 such that projection 20 extends inwardly toward the palm of the hand and tip 22 extends downwardly towards the strings. In this fashion, tip 22 may be used to pick or to strum a stringed instrument, such as an electric guitar. When it is desired to use head 24, pick 10 may be rotated clockwise about an axis of rotation generally perpendicular to surfaces 11 and 13 of body 12 through approximately 90 degrees such that head 24 now faces the guitar strings. Typically, although not necessarily, the pick continues to be held between the thumb and forefinger along edge 16. With the pick in this position, the guitarist may press the head 24 against individual strings on the fret board (or finger board), or against multiple strings depending upon the technique desired for hammering and/or tapping. Head 24 may be used to provide the style of play called “finger tapping.” Head 24 may replace a finger, and may be used to attack one or more strings with the picking hand, slamming the string onto the fret board (or finger board) and pulling off head 24 at a slight angle. This action activates the sound of the string at the fret where it is tapped, and the sound of the same string is open when released. This may be used for the legato technique previously described. If this technique is quickly repeated, it can produce an arpeggio type of sound.

This rotation of the pick from a position in which tip 22 faces the guitar strings to a position in which head 24 faces the guitar strings may be accomplished by pushing the middle finger of the hand holding the pick against projection 20 causing rotation of pick 10. In this way, the guitarist may move the pick easily and quickly from a position in which the guitarist is strumming or picking with tip 22 to a position in which head 24 is being used, without loss of control of the guitar pick.

In addition, pick 10 may be used to perform various slide techniques. These techniques may be performed by hitting one or more of the strings of the guitar with head 24, similar to a tapping technique, and then sliding the head 24 either up or down the neck of the instrument to produce sounds similar to a standard style of a slide guitar. Use of pick 10 permits the guitarist to use the picking hand rather than the hand holding the fret board (or finger board) to perform the slide technique, a result which is particularly convenient when playing live for an audience. In addition, head 24 may be used to make chromatic rakes, whereby head 24 is used to hit a fret and glide past several frets and back again to generate sounds of chromatic scale progressions.

Without limiting the generality of the foregoing, the following dimensions are given by way of example and not by way of limitation. Typically, the thickness of a body 12 is about the same as a typical medium thickness, plastic guitar pick. The thickness may be about 0.029 inch but range from about 0.01 to about 0.2 inch. The width of head 24 may range from about 0.1 to about 0.5 inch or more. The diameter of head 40 may range from about 0.1 to about 0.5 inch, while the diameter of head 50 may range from about 0.3 to about 0.7 inch.

In one embodiment, heads 24, 40, 50 and 60 may be made separately from pick body 12 and joined thereto using conventional techniques such as glue, or by heat sealing or welding. Alternatively, the pick body 12 and heads 24, 40, 50 and 60 may be molded integrally as a unit.

This invention is not limited in its application to the details of construction and the arrangement of components set forth in the description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein is meant to encompass the items listed thereafter and equivalents thereof, as well as additional items.

Having thus described several aspects of at least one embodiment of this invention, it is to be appreciated that various alterations, modifications and improvements will readily occur to those skilled in the art. Such alternations, modifications and improvements are intended to be part of this disclosure and are intended to be within the spirit and scope of the invention. Accordingly, the following description and drawings are by way of example only.

What is claimed is:

1. A pick for a stringed musical instrument, the pick comprising:
a pick body having a generally triangular shape and including a top edge, and two side edges, the two side edges extending from the top edge and intersecting at a location spaced from the top edge to form a tip; and
an enlarged head disposed adjacent one of the two side edges of the pick body, the head being spaced from the pick body, the head being rigidly secured to the pick body by two sides which extend from the head to opposite sides of the pick body.

2. The pick of claim 1 wherein an outer surface of the head facing away from the pick body has a rounded configuration.

3. The pick of claim 1 wherein an outer surface of the head facing away from the pick body has a generally planar configuration.

4. The pick of claim 1 wherein the head has the shape of a disc.

5. The pick of claim 1 wherein the head has a generally semi-cylindrical cross-sectional shape.

6. The pick of claim 1 wherein the sides of the head extend from the one of the two side edges of the pick body in a direction which is generally perpendicular to a line extending from the top edge to the tip.

7. The pick of claim 1 further comprising areas on portions of the pick body which have been roughened to enhance an ability to grasp the pick.

8. The pick of claim 1 wherein the pick body is formed of a plastic material.

9. The pick of claim 1 wherein the projection is formed of a metal.

10. A pick for a stringed musical instrument, the pick comprising:
a pick body having a generally triangular shape and including a top edge and first and second side edges, the first and second side edges extending from the top edge, and converging toward one another at a tip; and
a head disposed adjacent the first side edge of the pick body at a location spaced from the pick body, the head being rigidly secured to the pick body by two sides which extend from the head to the pick body so that the pick body is disposed between the sides of the head, the head having an outer surface on a side of the head facing away from the pick body which is configured to contact strings of the musical instrument;
the body of the pick being flexible relative to the head;
the top edge of the pick body being configured to be grasped by the hand of a musician to allow the musician to use the tip of the pick body to pick or strum strings of a musical instrument; and
the pick being rotatable through about 90° about an axis of rotation generally perpendicular to an outer surface of the pick body to allow the musician to grasp the pick along the second side edge and to place the outer surface of the head into contact with strings of a musical instrument.

11. The pick of claim 1 wherein the two sides of the head are tapered from the head toward opposite sides of the pick body so that the pick body is disposed between the two sides of the head.

12. The pick of claim 1 wherein the two sides of the head are substantially straight, one of the sides being affixed to one side of the pick body and the other side being affixed to the opposite side of the pick body so that the pick body is disposed between the two sides.

13. A pick for a stringed musical instrument, the pick comprising:
a pick body having a generally triangular shape and including a top edge, and two side edges, the two side edges extending from the top edge and intersecting at a location spaced from the top edge to form a tip; and
an enlarged head disposed adjacent one of the two side edges of the pick body at a location spaced from the pick body, the head being rigidly secured to the pick body by a single leg that extends from the head to the pick body, a portion of the leg spaced from the head being embedded within the pick body.
